(19) United States
(12) Patent Application Publication
(10) Pub. No.: US 2020/0356944 A1
(43) Pub. Date: Nov. 12, 2020

(54) Systems, Methods, and Devices for Recovering Carbon Dioxide for Reuse

(71) Applicant: Earthly Labs LLC, Austin, TX (US)

(72) Inventor: Amy George, Austin, TX (US)

(73) Assignee: Earthly Labs LLC, Austin, TX (US)

(21) Appl. No.: 16/865,254

(22) Filed: May 1, 2020

Related U.S. Application Data
(60) Provisional application No. 62/913,808, filed on Oct. 11, 2019.
(60) Provisional application No. 62/841,469, filed on May 1, 2019.

(51) Int. Cl. G06Q 10/08; G06Q 10/06; B01D 53/62; B01J 20/28; F25J 3/02

(52) U.S. Cl. CPC G06Q 10/087; G06Q 10/06315; F25J 3/0266; B01J 20/28045; B01D 53/62

(57) ABSTRACT

A device may include a plurality of controllable components, an input to receive a waste stream including carbon dioxide and volatile organic compounds, and a foam trap coupled to the input. The device may further include one or more sensors coupled to the input and configured to generate an electrical signal proportional to a concentration of at least one compound within the waste stream. The device may also include a control circuit coupled to the one or more sensors and configured to selectively activate one or more of the plurality of controllable components in response to the electrical signal.

### CROSS-REFERENCE TO RELATED APPLICATION(S)

The present disclosure is a non-provisional of and claims priority to U.S. Provisional Patent Application No. 62/841,469 filed on May 1, 2019 and entitled “Systems, Methods, and Devices for Recovering Carbon Dioxide for Reuse” and which is a non-provisional of and claims priority to U.S. Provisional Patent Application No. 62/913,808 filed on Oct. 11, 2019 and entitled “Systems, Methods, and Devices for Recovering Carbon Dioxide for Reuse”, which are incorporated herein by reference in their entireties.

### FIELD

The present disclosure is generally related to carbon dioxide recovery and, more particularly, to systems, methods, and devices for recovering carbon dioxide from fermentation and other processes at purity levels that allow for reuse in food and beverage production.

### BACKGROUND

Fermentation of sugars by yeast to generate ethanol produces carbon dioxide as a byproduct. For each molecule of ethanol generated, a molecule of carbon dioxide is also generated. Generally, carbon dioxide produced within a fermentation tank as a byproduct of the fermentation process may be released to avoid stalling of the fermentation process and to avoid over-pressurizing the fermentation tank.

### SUMMARY

Embodiments of systems, methods, and devices are described below that may be configured to receive a waste stream, such as a waste stream produced by a fermentation tank, and to process the waste stream to recover carbon dioxide at a level of purity that allows the recovered carbon dioxide to be reused in a variety of applications, such as in food or beverage production. In an example, the recovered carbon dioxide may be used for forced carbonation and purging of tanks and process lines. In some instances, the recovered carbon dioxide may be packaged and resold to consumers of beverage-grade carbon dioxide, such as nearby restaurants, microbreweries, and so on.

In some embodiments, a device may include a plurality of controllable components, an input to receive a waste stream including carbon dioxide and volatile organic compounds, and a foam trap coupled to the input. The device may further include one or more sensors coupled to the input and configured to generate an electrical signal proportional to a concentration of at least one component within the waste stream, such as an element of the periodic table (e.g., Oxygen) or a molecule (e.g., carbon dioxide). The device may also include a control circuit coupled to the one or more sensors and configured to selectively activate one or more of the plurality of controllable components in response to the electrical signal. In some implementations, the control circuit may communicate data related to the one or more sensors to a computing device through the network. The computing device may be a computer server or another computing device. For example, the control circuit may determine an amount of CO₂ that has been recovered and may provide such data to the computing device. Other embodiments are also possible.

In one example, a device may be configured to receive a waste stream from a fermentation process (or from another waste stream source). The device may be configured to measure the oxygen concentration within the waste stream. When the oxygen concentration is less than a threshold value, the device may vent the waste stream to atmosphere and reduce power to one or more other components. When the oxygen concentration is greater than or equal to the threshold value, the device may activate one or more components to extract carbon dioxide from the waste stream and to purify the extracted carbon dioxide to produce a purified carbon dioxide output stream. In some implementations, the purified carbon dioxide output stream may be pure enough for reuse in food processes, beverage processes, or both. In some implementations, the control circuit may determine a volume of captured CO₂ and provide data to a computing device that is indicative of the volume of the captured CO₂. Other implementations are also possible.

In some implementations, a system may include a communication interface configured to couple to a network and a processor coupled to the interface. The processor may be configured to receive first data corresponding to an available quantity of carbon dioxide (CO₂) from one or more CO₂ capture devices and provide an interface to one or more computing devices through the network. The interface may include data related to the available quantity of CO₂ and may include one or more control options accessible by a user to purchase a selected portion of the available quantity. The processor may be configured to receive second data corresponding to selections from the interface from a purchaser, where the selections including a selected quantity from the available quantity of CO₂. The processor may also automatically coordinate one or more of pickup or delivery of the selected quantity. Other implementations are also possible.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a system including a device for recovering carbon dioxide (CO₂) for reuse, in accordance with certain embodiments of the present disclosure.

FIG. 2 depicts a block diagram of a system including a device for recovering carbon dioxide for reuse, in accordance with certain embodiments of the present disclosure.

FIG. 3 depicts a block diagram of a control circuit of the device of FIGS. 1 and 2, in accordance with certain embodiments of the present disclosure.

FIG. 4 depicts a block diagram of the system of FIGS. 1 and 2 including a local server communicatively coupled to the device, in accordance with certain embodiments of the present disclosure.

FIG. 5 depicts a block diagram of the system of FIGS. 1 and 2 including a control and maintenance server coupled to the device, in accordance with certain embodiments of the present disclosure.

FIG. 6 depicts a diagram of components of the system of FIGS. 1 and 2, in accordance with certain embodiments of the present disclosure.

FIG. 7 depicts a diagram of a graphical interface that may be presented on an interface of the device of FIGS. 1 and 2, in accordance with certain embodiments of the present disclosure.

FIG. 8 depicts a diagram of a graphical interface that may be presented on an interface of the device of FIGS. 1 and 2, in accordance with certain embodiments of the present disclosure.

FIG. 9 depicts a flow diagram of a method of selectively activating a device for recovering carbon dioxide, in accordance with certain embodiments of the present disclosure.

FIG. 10 depicts a diagram of an interface with which a consumer may interact to purchase a quantity of captured CO₂, in accordance with certain embodiments of the present disclosure.

FIG. 11 depicts a flow diagram of a method of providing captured CO₂, in accordance with certain embodiments of the present disclosure.

While implementations are described in this disclosure by way of example, those skilled in the art will recognize that the implementations are not limited to the examples or figures described. It should be understood that the figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of systems, methods, and devices are described below that may be used for monitoring and operating remote field equipment over a data network with applications to fermentation processes. For example, the systems, methods, and devices may be used to capture and process carbon dioxide from a fermentation process, such as from production of alcohol. In some implementations, a system may include a device for recapturing carbon dioxide. The device may include one or more sensors, a processor, and processor-executable instructions that may cause the processor to analyze, measure, communicate, impact, and control a carbon dioxide (CO₂) gas capture process. The device may produce food grade CO₂ gas that may be reused or sold for reuse.

In some implementations, the device may determine an amount of captured CO₂ gas and may provide an interface through which a third-party may purchase a portion of the captured CO₂ gas. The interface may be provided on the Internet or may be sent to one or more third-parties who have signed up to receive offers. Other implementations are also possible.

In some implementations, the device may be implemented as a piece of remote field equipment for capturing CO₂ gas. The device may utilize a set of chemical process input parameters and a set of desired chemical process output parameters. The device may communicate data through a network, such as the Internet, to one or more computing devices, which may utilize remote monitoring software, analysis software, or other instructions for data analytics. In some instances, the software may include an open application programming interface (API) that allows customers to import data and to track the impact of the CO₂ recovery process in real-time or near real-time. Further, in some implementations, a portion of such information may be shared with a customer application executing on a customer device, such as a smartphone. For example, a loyalty application executing on a customer device may be configured to receive information related to the CO₂ recovery process and may provide a visual display or other indicator that represents the CO₂ recovery by or at the particular location.

In certain implementations, a CO₂ recovery device may include an input configured to receive a waste stream including CO₂ gas, volatile organic compounds (VOCs), water, other components, or any combination thereof. The device may include a control circuit configured to receive sensor signals associated with the waste stream, to process the sensor signals to determine the concentration of one or more compounds within the waste stream, and to selectively control one or more components of the device based on the sensor signals to recover CO₂ gas from the waste stream.

In an implementation, the control circuit may receive a sensor signal indicating a concentration of oxygen within the waste stream and compare the amount to a threshold. When the concentration is less than the threshold, the control circuit may selectively control a valve to vent the waste stream and to deactivate one or more other components (such as compressors, dryers, scrubbers, and chillers). When the concentration is equal to or greater than the threshold, the control circuit may close the valve and control one or more other components of the device to capture and process the waste stream to capture CO₂ and produce a reusable CO₂ gas. In some implementations, the produced CO₂ gas may be of sufficient quality that it could be reused in food processes, such as food production, beverage production, beverage consumption, and the like. In some implementations, the reusable CO₂ may be used in a greenhouse environment to stimulate plant growth.

The International Society of Beverage Technologists (ISBT) has defined standards for beverage-grade CO₂. The standards require a minimum of 99.9% purity by volume and a maximum of 30 ppm by volume of oxygen contamination. Many of the contaminants identified by the ISBT are not present in beer fermentation, including ammonia, nitric oxide, nonvolatile residue, phosphine, and aromatic hydrocarbons. However, such compounds may be present in processes that are conventional sources of industrial or residential CO₂.

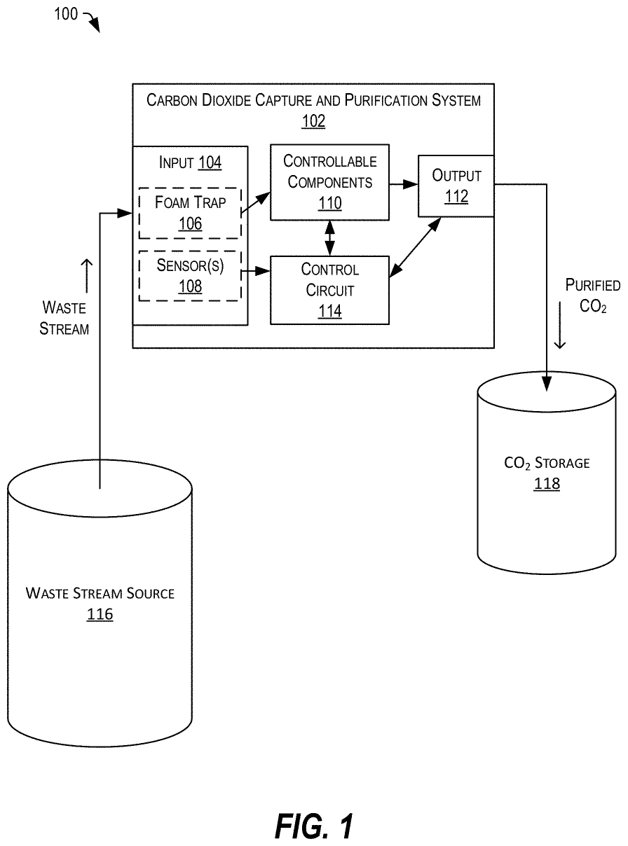

In the following discussion, embodiments of systems and methods are described that may be configured to recover beverage-grade CO₂ from a waste stream of a fermentation process, such as a beer fermentation process. To accommodate other types of waste streams, additional components may be added or included to remove some of the other types of contaminants from the waste stream in order to produce the beverage-grade CO₂, which may be reused within the fermentation process or for other purposes. One implementation of a device configured to capture and process a waste stream of a fermentation process to produce beverage-grade CO₂ is described below with respect to FIG. 1.

FIG. 1 depicts a block diagram of a system 100 including a device 102 for recovering CO₂ for reuse, in accordance with certain embodiments of the present disclosure. The device 102 may be an implementation of a CO₂ capture and purification system, which may be configured to receive a waste stream that includes CO₂ as well as other compounds, such as water, nitrogen, other waste, or any combination thereof. The waste stream may be received from a waste stream source 116, such as a fermentation tank or other another source.

The device 102 may include an input 104, which may include a foam trap 106 and one or more sensors 108. The foam trap 106 may be configured to remove water and excess foam carried by the waste stream. The one or more sensors 108 may be positioned at the input to the foam trap 106, within the foam trap 106, at an output of the foam trap 106, or any combination thereof. The one or more sensors 108 may be configured to measure at least one parameter or attribute of the waste stream. In a particular implementation, the measured parameter may include the oxygen concentration within the waste stream.

The device 102 may include one or more controllable components 110, which may be arranged in a particular sequence. The controllable components 110 may include valves, compressors, heaters, scrubbers, dryers, chillers, other components, or any combination thereof. The controllable components 110 may also include a plurality of sensors as well as actuators that may be controlled by a control circuit 114. Further, the controllable elements 110 may be coupled to an output 112, which may be coupled to one or more storage tanks 118 configured to store liquefied CO₂. When activated by the control circuit 114, the controllable components 110 may extract and purify CO₂ from the waste stream to produce a liquefied CO₂ stream for storage and reuse.

In some implementations, the control circuit 114 may receive signals from the one or more sensors 108 indicative of the concentration of one or more compounds within the waste stream. In one implementation, the one or more parameters may include a measurement of at least one type of compound at a concentration about a threshold concentration, for example, in parts per million. For example, when the one or more sensors 108 may measure the oxygen content, in parts per million, and when the oxygen content equals or exceeds a predetermined threshold, the control circuit 114 may activate the controllable elements 110 to process the waste stream to extract the purified CO₂. When the concentration of oxygen is less than the threshold level, the control circuit 114 may vent the waste stream to atmosphere (or at least turn off the flow of the waste stream into the device 102) and turn off or reduce power to the controllable components 110. The controllable elements 114 may continue to monitor the waste streams while the controllable components 110 remain in a low-power or “off” state. Subsequently, when the received signals from the one or more sensors 108 indicate a concentration of a particular compound within the waste stream that is greater than or equal to the threshold, the control circuit 114 may activate the controllable components 110 to process the waste stream to capture, scrub, and liquefy the CO₂ for storage and reuse.

By controlling the device 102 to operate only when the concentration of a selected compound is above the threshold level, not only is the efficiency of the device 102 enhanced, but the overall quality and purity of the recovered CO₂ is also enhanced. For example, when the concentration of oxygen in the waste stream is below the threshold level, recovery of CO₂ may use more energy and may take longer than when the concentration is at or above the threshold concentration. Accordingly, controlling the operation of the controllable elements 110 to function only when the concentration of oxygen (or other selected compounds) equals or exceeds the threshold ensures efficient processing and recapture of the CO₂ from the waste stream.

In an implementation, one or more sensors 108 may be located between the foam trap 106 and a first of the controllable components 110 to measure the concentration of one or more compounds within the waste stream, such as the concentration of oxygen, the concentration of nitrogen, the concentration of other compounds, or any combination thereof. The control circuit 114 may activate the controllable components 110 to process the CO₂ within the waste stream when the one or more sensors 108 detect a concentration of oxygen that is at or above a threshold concentration. The threshold concentration may be 0.05 ppm, may be approximately 0.08 ppm, and so on. Other concentrations are also possible.

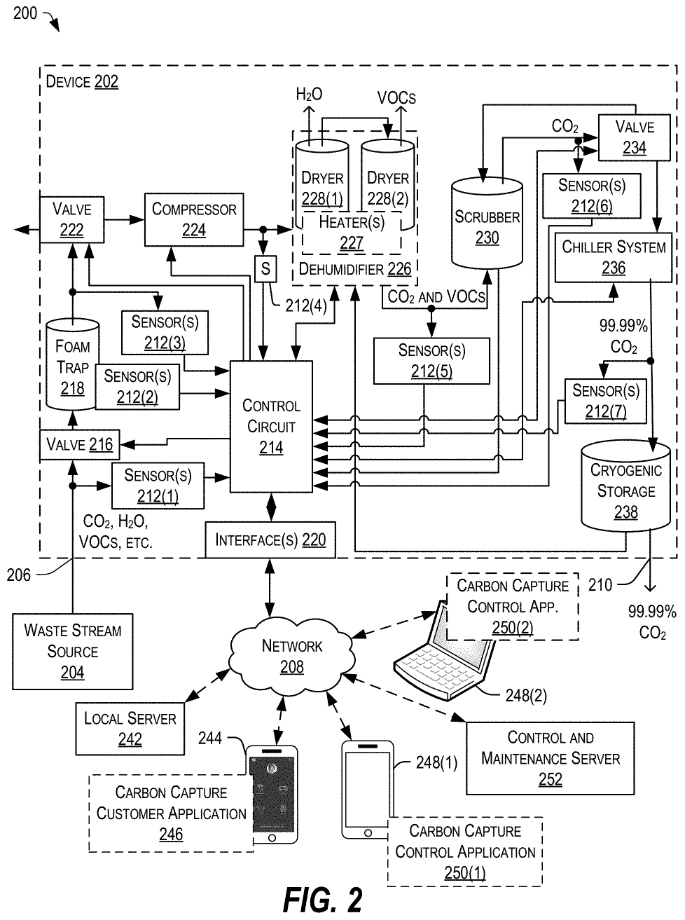

It should be appreciated that the device 102 represents a simplified diagram of the CO₂ capture and purification device. One implementation of the device 102 depicting more details is described below with respect to FIG. 2.

FIG. 2 depicts a block diagram of a system 200 including a device 202 for recovering CO₂ for reuse, in accordance with certain embodiments of the present disclosure. The device 202 may be an implementation of the device 102 of FIG. 1. In the illustrated example, the device 202 may be coupled to a waste stream source 204 to receive a waste stream at an input 206 and to provide purified CO₂ at an output 210 of the device 202. In some implementations, the purified CO₂ at the output 210 may be in liquid form.

The device 202 may be configured to communicate with one or more other devices through a network 208, such as the Internet, a cellular network, a satellite network, a local area network, a Bluetooth® network, another network, or any combination thereof. The device 202 may be configured to communicate through the network 208 with a local server 242, a computing device 244 (e.g., a smartphone) including a carbon capture customer application 246, a computing device 248(1) (e.g., a smartphone) including a carbon capture control application 250(1), a computing device 248(2) (e.g., a laptop, tablet, or other computing device) including a carbon capture control application 250(2), a control and maintenance server 252, other computing devices, or any combination thereof.

The device 202 may include a foam trap 218 including an input coupled to the input 206 through a valve 216. The foam trap 218 may include an output coupled to a compressor 224 through a valve 222. The foam trap 218 may be configured to remove foam carry over from the waste stream to protect downstream components. The device 202 may include one or more sensors 212(1) coupled to the input 206 and to the control circuit 214. The device 202 may further include one or more sensors 212(2) coupled to the foam trap 218 and to the control circuit 214. Additionally, the device 202 may include one or more sensors 212(3) coupled to the output of the foam trap 218 and to the control circuit 214. The sensors 212 may include temperature sensors, moisture sensors, oxygen sensors, other sensors, or any combination thereof.

The control circuit 214 may include a microcontroller unit (MCU) and a memory (or a processor and a memory). The memory may be configured to store data and instructions that may be executed by the MCU or processor to control operation of the device 202. The control circuit 214 may also be coupled to one or more interfaces 220, which may enable to communication with one or more devices through a wired or wireless connection and optionally through the network 208. In some implementations, the control circuit 214 may send data to one or more devices through the network 208 and may receive control signals, processor-readable instructions, data, or any combination thereof from the network 208 via the one or more interfaces 220. The control circuit 214 may be configured to receive software updates, adjustments to thresholds, data, or any combination thereof through the network 208. The one or more interfaces 220 may include an Ethernet port, a universal serial bus (USB) port, another type of physical connector, a Bluetooth® transceiver, a short-range wireless transceiver (such as an IEEE 802.11x compatible transceiver), another type of wireless transceiver, another communication circuit interface, or any combination thereof.

The device 202 may further include a valve 222 including an input coupled to the output of the foam trap 218, a control input coupled to the control circuit 214, a first output configured to vent the waste stream to atmosphere, and a second output configured to direct the waste stream to a compressor 224. The compressor 224 may include an input to receive the waste stream, a control input coupled to the control circuit 214, and an output to provide a compressed waste stream.

The device 202 may further include one or more sensors 212(4) coupled to the output of the compressor and configured to provide sensor signals to the control circuit 214. The device 202 may further include a dehumidifier 226 including an input coupled to the output of the compressor 224, a control interface coupled to the control circuit 214, and an output. The dehumidifier 226 may include a pair of dryers 226(1) and 226(2) (which may be implemented as desiccant beds) configured to withdraw moisture from the compressed waste stream. The dehumidifier 226 may also include one or more heaters 227, which may deliver heat to the dryers 226(1) and 226(2) in response to control signals from the control circuit 214. The dryers 226(1) and 226(2) may be configured to remove moisture and volatile organic compounds (VOCs) from the compressed waste stream and to provide a dehumidified waste stream to a scrubber 230 coupled to the output of the dehumidifier 226. In some implementations, the dehumidified waste stream may include CO₂ and VOCs.

The device 202 may include one or more sensors 212(5) coupled to the output of the dehumidifier 226 and coupled to the control circuit 214. The scrubber 230 may include an input coupled to the output of the dehumidifier 226, a control input coupled to the control circuit 214, and an output configured to provide a scrubbed waste stream including CO₂ and possibly including at least some contaminant compounds. The device 202 may further include one or more sensors 212(6) coupled to the output of the scrubber 230 and coupled to the control circuit 214. The device 202 may also include a valve 234 including an input coupled to the output of the scrubber 230, a control input coupled to the control circuit 214, a feedback output coupled to the scrubber 230 to return the stream to the scrubber 230 for further processing, and a second output coupled to a chiller system 236.

The device 202 may further include the chiller system 236 including an input coupled to the second output of the valve 234. The chiller system 236 may include a control input coupled to the control circuit 214 and an output configured to provide a liquefied CO₂ stream that meets or exceeds beverage-grade CO₂ purity standards. In some implementations, the chiller system 236 may include an auto cascade refrigeration system, which may use a single refrigeration compressor to circulate a mixture of refrigerants in a closed-loop, auto cascade refrigeration cycle. In an implementation, the condenser of the chiller system 236 may be air-cooled, such that the chiller system 236 does not rely on a chilled glycol utility stream. Because of the mixture of refrigerants, the auto cascade, closed-loop cycle of the chiller system 236 may develop a two-phase vapor-liquid system within the chiller system 236. The liquid phase may then pass across a pressure reducing device, causing further cooling and exchanging heat with the vapor stream to partially condense the refrigerant in preparation a final refrigeration evaporator heat exchanger. The chiller system 236 may have lower pressure operating points as compared to conventional CO₂ recovery technology, and may be capable of achieving a low process temperatures ranging from −80 to −30 degrees Celsius or even colder temperatures, as desired.

The device 202 may include one or more sensors 212(7) coupled to the output of the chiller system 236 and to the control circuit 214. The device 202 may further include or may be coupled to a cryogenic storage 238, which may be coupled to the output of the chiller system 236 and configured to store liquefied CO₂. In some implementations, the cryogenic storage 238 may be external to the device 202 or the device may include an internal cryogenic storage 238 and an output 210 that may be selectively coupled to one or more additional tanks for storage of liquefied CO₂. The CO₂ storage 118 of FIG. 1 may be an example of the cryogenic storage 238 or of an additional tank for storage of liquefied CO₂. Other implementations are also possible.

Each of the sensors 212 may be configured to generate an electrical signal proportional to a particular element or compound with a stream and to provide the electrical signal to the control circuit 214. In some implementations, each of the one or more sensors 212 may provide a digital signal to the control circuit 214. In other implementations, the control circuit 214 may include one or more analog-to-digital converters (ADCs) configured to convert the sensor signals into data that may be processed by the control circuit 214.

In operation, the control circuit 214 may be configured to control operation of each of the valves 216, 222, and 234 as well as the operation of the compressor 224, the dehumidifier 226, the heaters 227, the scrubber 230, and the chiller system 236 to process a waste stream to capture, scrub, and liquefy CO₂ for reuse. In some implementations, the control circuit 214 may compare a signal from the one or more sensors 212 to a threshold concentration value. When the signal indicates a concentration of a compound within the waste stream that is below the threshold concentration value, the control circuit 214 may control the valve 216 to prevent flow of the waste stream to the foam trap 218 and may control the compressor 224, the dehumidifier 226, the heaters 227, the scrubber 230, and the chiller system 236 to enter a low power or “off” state, reducing overall power consumption. When the signal indicates a concentration that is equal to or greater than the threshold concentration value, the control circuit 214 may control the valve 216 to allow the waste stream to flow into the foam trap 218 and may activate the compressor 224, the dehumidifier 226, the scrubber 230, and the chiller system 236 to process the waste stream.

The distribution of sensors 212 enables the control circuit 214 to monitor selected compounds and parameters of the waste stream at a plurality of stages within the CO₂ capture and recovery process. In response to the sensor signals, the control circuit 214 may selectively control operation of one of more of the valves 216, 222, and 234, the compressor 224, the dehumidifier 226, the heaters 227, the scrubber 230, and the chiller system 236 to control the production of the CO₂. In some implementations, the control circuit 214 may selectively adjust one or more parameters of the process over time to enhance the production volume and efficiency of the CO₂ capture process based on analysis of the measurement data, based on control signals from an interface or from a computing device, based on updated instructions, or any combination thereof.

In some implementations, the control circuit 214 may be configured provide the alert to a computing device (such as computing device 248(1), computing device 248(2), or both) through the network 208 or to a peripheral device (such as display, a visual indicator, a speaker, or another device) through the interface 220 when the oxygen content at the input 206 is below a threshold. In one implementation, sensor signals may provide an indication of a component in need of servicing, a failed component, and so on. For example, if sensors 212(5) indicate a moisture level that is above a moisture threshold level, the control circuit 214 may determine that the dryers 228 (desiccant beds) may need to be serviced. In an example, the control circuit 214 may provide signals to one or more valves to direct the waste stream through one of the dryers 228 while controlling one or more other valves to provide regenerative gas and optionally heat to the other dryer 228. Other implementations are also possible.

Further, the control circuit 214 may be configured to maintain data corresponding to the capture of CO₂ and may present the data to a display or may send the data to a computing device 248 through the network 208. For example, in one implementation, the control circuit 214 may send an alert the computing device 248 indicative of a state of one or more of the components. Other implementations are also possible.

In an example, the control circuit 214 may provide data and status information to the local server 242 through the network 208 and optionally to a control and maintenance server 252. In some implementations, the control and maintenance server 252 may provide updated instructions and optionally parameter adjustments to the control circuit 214, which may control one or more of the components based on the received updated instructions or parameter adjustments.

The control circuit 214 may communicate with computing device 248(1), computing device 248(2), another computing device, or any combination thereof. In this example, the computing devices 248(1) and 248(2) may execute a carbon capture control application 250(1) and 250(2), respectively. A user may interact with the carbon capture control application 250(1) or 250(2), via an input interface (and optionally a separate display interface) of the computing device 248(1) or 248(2) to manage and control operation of the device 202. Other implementations are also possible.

The control circuit 214 or the local server 242 may provide data to the carbon capture customer application 246 executing on a computing device 244, such as a smartphone. The carbon capture customer application 246 may present the data in a format that may be of interest to the customer. Other implementations are also possible.

In some implementations, the captured CO₂ gas may be reused within the fermentation process from which the CO₂ gas was captured. The control circuit 214 may be configured to predict the volume of captured CO₂ gas based on recovery data from the sensors 212(7) over time. The control circuit 214 may determine excess CO₂ gas (i.e., a volume of CO₂ gas that is not needed for reuse within the fermentation process from which the CO₂ gas was captured), and may provide data to a local server 242 (or to another server or computing device), which may make the excess CO₂ gas available for purchase by a third-party. For example, the local server 242 may communicate with a server through the network 208 to provide information indicative of a quantity of CO₂ that is available for purchase. The control circuit 214 may provide data indicative of the quantity of excess CO₂ gas. In an example, the quantity may be based on one or more standard CO₂ canister sizes, and the excess CO₂ gas may be available for purchase in quantities corresponding to the canister sizes or in custom quantities, depending on the implementation.

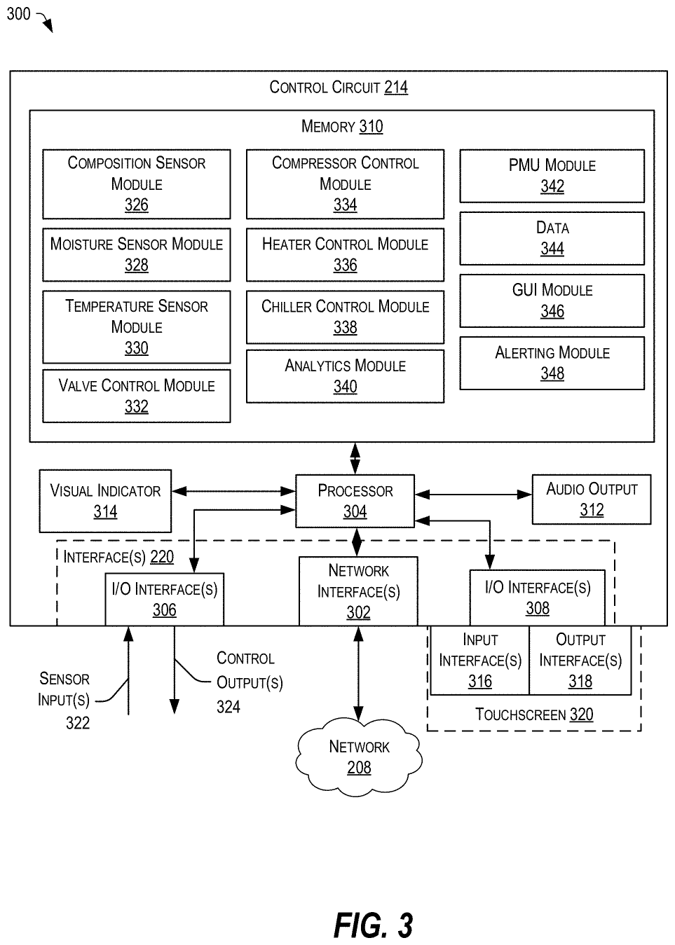

FIG. 3 depicts a block diagram 300 of a control circuit 214 of the device 102 or 202 of FIGS. 1 and 2, in accordance with certain embodiments of the present disclosure. In the illustrated example of FIG. 2, the control circuit 214 is depicted as being separate from the interfaces 220. However, the interfaces 220 may be part of the control circuit 214. In this example, the interfaces 220 are depicted with dashed lines to indicate that they could be located within the control circuit 214 or may be coupled to the control circuit 214.

The interfaces 220 may include one or more network interfaces 302 configured to communicatively couple to the network 208 to send data to and receive data and instructions from one or more devices via the network 208. The control circuit 214 may include a processor 304 coupled to the one or more network interfaces 302. The control circuit 214 may further include one or more input/output (I/O) interfaces 306 coupled to the processor 304. The I/O interfaces 306 may be configured to receive sensor inputs 322 and to provide control outputs 324. The control circuit 214 may also include one or more I/O interfaces 308 coupled to the processor 304. The I/O interfaces 308 may be configured to provide display data to one or more output devices 318 and to receive input data from one or more input devices 3′6. In one example, the input devices 316 and the output devices 318 may be combined in the form of a touchscreen 320. In another implementation, the I/O interfaces 308 may be coupled to one or more input devices 316 including a keypad, a pointer, another input device, or any combination thereof. The I/O interface 308 may also be coupled to one or more output devices 318, such as display, a printer, a light, other devices, or any combination thereof.

The control circuit 314 may further include an audio output 312 coupled to the processor 304. The audio output 312 may include or be coupled to a speaker configured to generate an audible output. The control circuit 314 may also include a visual indicator 314 coupled to the processor 304 and configured to provide a visual alert. The visual indicator 314 may include one or more light-emitting diodes or other controllable light sources. The control circuit 214 may also include a memory 310 configured to store data and instructions that may be executed by the processor 304 to monitor and control various components to process the waste stream to produce CO₂ for reuse.

The memory 310 may include a constituent or composition sensor module 326 that, when executed, may cause the processor 304 to receive sensor signals from the one or more sensors and to determine parameters associated with one or more contents within the stream based on the sensor signals. The component sensor module 326 may be configured to detect elements (such as Oxygen) or compounds (such as CO₂) within the waste stream. The memory 310 may also include a moisture sensor module 328 that, when executed, may cause the processor 304 to receive sensor data corresponding to moisture levels within the waste stream. The memory 310 may also include a temperature sensor module 330 that, when executed, may cause the processor 304 to receive temperature data associated with one or more stages of the process.

The memory 310 may also include a valve control module 332 that, when executed, may cause the processor 304 to control operation of one or more of the valves. The processor 304 may control the valves based on data 344 determined from one of more of the sensors. The memory 310 may include a compressor control module 334 that, when executed, may cause the processor 304 to control operation of the compressor 224.

The memory 310 may include a heater control module 336 that, when executed, may cause the processor 304 to control operation of the heaters 227. The memory 310 may include a chiller control module 338 that, when executed, may cause the processor 304 to control operation of the chiller system 236. The memory 310 may also include an analytics module 340 that, when executed may cause the processor 304 to compare the sensor signals to one or more thresholds and to determine adjustments for one or more of the components based on the sensor data and the comparisons.

In some implementations, the analytics module 340 may cause the processor 304 to evaluate sensor data and CO₂ production data over time to determine operational values for the various components, which operational values may enhance the CO₂ production volume, efficiency, quality, or any combination thereof. For example, a particular temperature setting, a particular pressure, a particular heater value, or another setting may result in lower power consumption and higher production over time, and the analytics module 340 may cause the processor 304 to determine such settings. Further, the analytics module 340 may cause the processor 304 to determine whether and when to control the valves. The analytics module 340 may also cause the processor 304 to determine excess CO₂ gas, which may be made available to third-parties for purchase. Other implementations are also possible.

The memory 310 may include a power management unit module 342 that, when executed, may cause the processor 304 to selectively turn off power or reduce power to one or more of the components. For example, the analytics module 340 may cause the processor 304 to determine that the amount of CO₂ within the waste gas stream is below a threshold level and may close a valve at the input to the foam trap 218 and control the power management unit 342 to turn off or reduce power to one or more other components.

The memory 310 may further include data 344 determined from the one or more sensors, thresholds, settings, parameters, other data, or any combination thereof. The memory 310 may also include a graphical user interface (GUI) module 346 that, when executed, may cause the processor 304 to generate a graphical interface that may be provided to the touchscreen 320 or that may be communicated to a computing device through the network 208. The memory 310 may also include an alerting module 348 that, when executed, may cause the processor 304 to activate the visual indicator 314, to generate an audio alert via the audio output 312, to send a message or report to the touchscreen 320, to a computing device through the network 208, or any combination thereof. For example, the alerting module 348 may cause the processor 304 to send data to one or more computing devices through the network 208 where the data is indicative of excess CO₂ gas that is available for purchase. The data may include a volume of CO₂ gas as well as a location where the CO₂ gas is stored. In some implementations, the data may include contact information for an individual that has authority to distribute the excess CO₂ gas so that a third-party may arrange to purchase the quantity. Other implementations are also possible.

In some implementations, the control circuit 214 may be configured to determine the concentration of an element or a compound within the waste stream at the input of the device 202 and may selectively deactivate the various components when the concentration is below a threshold level, such as by using the power management unit 342 to cause the processor 304 to reduce power to those components. For example, the control circuit 214 may place one or more components in an idle or low power state when the concentration is below a threshold level. Further, the control circuit 214 may activate the components to produce CO₂ for reuse when the concentration is equal to or exceeds the threshold, such as by delivering power to the components.

The control circuit 214 may also monitor the moisture content in the dehumidifier 226 and may selectively activate the heaters 227 to assist in the moisture removal process. Further, the control circuit 214 may selectively adjust the compressor 224, the chiller system 236, or other components. In some implementations, the adjustments may be based on signals from the one or more sensors. In other implementations, the adjustments may be based on control signals received from the interface 308 or from a computing device through the network 208. Other implementations are also possible.

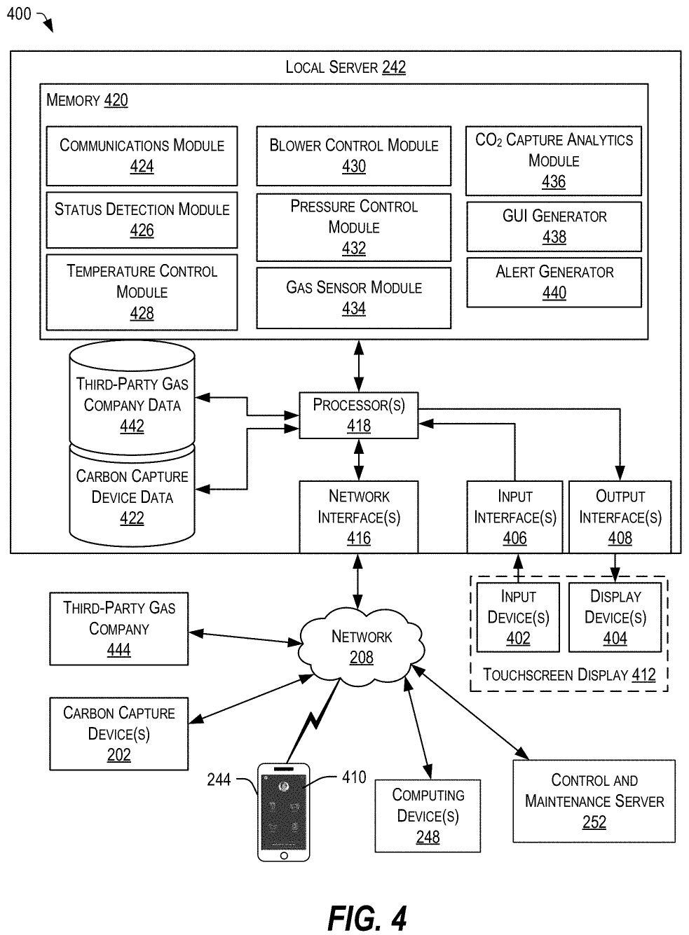

FIG. 4 depicts a block diagram 400 of the system 100 or 200 of FIGS. 1 and 2, including a local server 242 communicatively coupled to the device 102 or 202, in accordance with certain embodiments of the present disclosure. The local server 242 may be configured to provide an interface to monitor and control one or more CO₂ capture devices 102 or 202. The system 400 may include all of the elements of the systems 100, 200, and 300 of FIGS. 1-3.

The local server 242 may be configured to communicate with a control and maintenance server 252, a computing device 244, a carbon capture device 202, one or more computing devices 248, and other devices through the network 208. The local server 242 may also communicate with a computer server of a third-party gas company 444, websites, and various corporate systems through the network 208. The computing devices 248 may include a smartphone, a tablet computer, a laptop computer, another computing device, or any combination thereof. The local server 242 may also communicate with a computing device 244, which may present a graphical interface 410 on its touchscreen display including data about the CO₂ capture process of a particular CO₂ capture device 202. Other implementations are also possible.

The local server 242 may also be coupled to an input device 402 (such as a keyboard, a touch-sensitive surface, a pointer, another device, or any combination thereof) to receive operator input and a display device 404 to display a graphical interface including data and selectable options. In some implementations, the input device 402 and the display device 404 may be combined as a touchscreen display 412. Other implementations are also possible.

The local server 242 may include a network interface 416 coupled to the network 208. The local server 242 may further include a processor 418 coupled to the network interface 216. Further, the local server 242 may include an input interface 406 coupled to the input device 402 and an output interface 408 coupled to the display device 404. The processor 418 may be coupled to the input interface 406 and the output interface 408. The local server 242 may further include a memory 420 coupled to the processor 418 and configured to store data and instructions that, when executed, may cause the processor 418 to perform a variety of monitoring, control, and communication functions. The local server 242 may also include databases, such as third-party gas company database 442 and carbon capture device data 422. The third-party gas company database 442 may store data corresponding to companies that might be able to utilize and/or transport purified CO₂ gas generated and stored by the CO₂ capture device 202. The carbon capture device data 422 may be configured to store data associated with each of a plurality of CO₂ capture devices 202, including production information, data related to sensor measurements, parameter data, other data, or any combination thereof.

The memory 420 may include a communications module 424 that, when executed, may cause the processor 418 to communicate with the CO₂ capture devices 202 and with other devices to receive information, to search for information, and so on. The communications module 424 may cause the processor 418 to communicate with each of a plurality of CO₂ capture devices 202 periodically, according to a pre-determined schedule, or continuously to retrieve the information. In some examples, the communications module 424 may be configured to passively receive the information. In some implementations, the communications module 424 may cause the processor 418 to receive data, such as sensor measurement data, purified CO₂ gas production data, parameter data, and other data from one or more CO₂ capture devices 202.

The memory 420 may also include a status detection module 426 that, when executed, may cause the processor 418 to determine a status of various components of at least one of the CO₂ capture devices 202 based on the received data. The status may include a state of a valve (open, closed, stuck, and so on), a state of the purified CO₂ storage device (such as the cryogenic storage 238 of FIG. 2), the state of various other components (such as scrubbers, blowers, compressors, sensor measurement data, and so on), or any combination thereof.

The memory 420 may include a temperature control module 428 that, when executed, may cause the processor 418 to determine a temperature of one or more components. Further, in response to determining the temperature, the temperature control module 428 may selectively determine one or more adjustments to parameters associated with components of the associated CO₂ capture device 202 that may be controlled to maintain the temperature within a pre-determined temperature range.

The memory 420 may also include a blower control module 430 that, when executed, may cause the processor 418 to determine information related to one or more blower components of the CO₂ capture device 202. Additionally, the blower control module 430 may cause the processor 418 to selectively determine one or more adjustments to parameters of the blower components of the associated CO₂ capture device 202 to adjust the output of the blowers.

The memory 420 may also include a pressure control module 432 that, when executed, may cause the processor 418 to determine information related to the fluid pressure at various points within the CO₂ capture process performed by the CO₂ capture device 202. In some implementations, the pressure control module 432 may be configured to cause the processor 418 to selectively determine one or more adjustments to parameters of one or more components the associated CO₂ capture device 202 to control the fluid pressure.

The memory 420 may also include a gas sensor module 434 that, when executed, may cause the processor 418 to extract the sensor measurement data from the data received from the CO₂ capture device 202. Further, the memory 420 may include a CO₂ capture analytics module 436 that, when executed, may cause the processor 418 to process the received data and the data determined by the status detection module 426, the temperature control module 428, the blower control module 430, the pressure control module 432, and the gas sensor module 434 to determine one or more adjustments associated with the CO₂ capture device 202. In some implementations, the CO₂ capture analytics module 436 may be configured to process data from each of a plurality of CO₂ capture devices 202, to determine parameters and settings that may enhance the CO₂ production for each CO₂ capture device 202 individually and optionally for establishing default settings that may provide an initial approximation for optimal production of purified CO₂ gas from the waste gas stream. In some implementations, the CO₂ capture analytics module 436 may provide recommended settings and suggested adjustments to an operator via a graphical interface.

The memory 420 may include a graphical user interface (GUI) generator 438 that, when executed, may cause the processor 418 to generate a graphical interface including data related to at least one CO₂ capture device 202 and including selectable options accessible by an operator to review the data, to adjust one or more operating settings of the CO₂ capture device 202, to communicate with other computing devices, or any combination thereof.

In some implementations, the memory 420 may include an alert generator 440 that, when executed, may cause the processor 418 to monitor one or more parameters of the CO₂ capture device 202 and to selectively generate an alert for transmission to a computing device when, for example, one or more components of the CO₂ capture device 202 are malfunctioning, production falls below a threshold production level, or some other measurement requires an operator's attention.

In some implementations, the alert generator 440 may cause the processor 418 to push CO₂ production statistics to an application executing on a computing device, such as the computing device 244, the computing devices 248, the control and maintenance server 252, or any combination thereof. Further, the alert generator 440 may cause the processor 418 to send text messages, email messages, voice messages, or any combination thereof (i.e., an alert) in response to determining (from the information determined by the CO₂ capture analytics module 436) and optionally in response to comparing the information to one or more thresholds. In a particular example, the alert may be sent in response to a parameter exceeding or falling below a threshold. Other implementations are also possible.

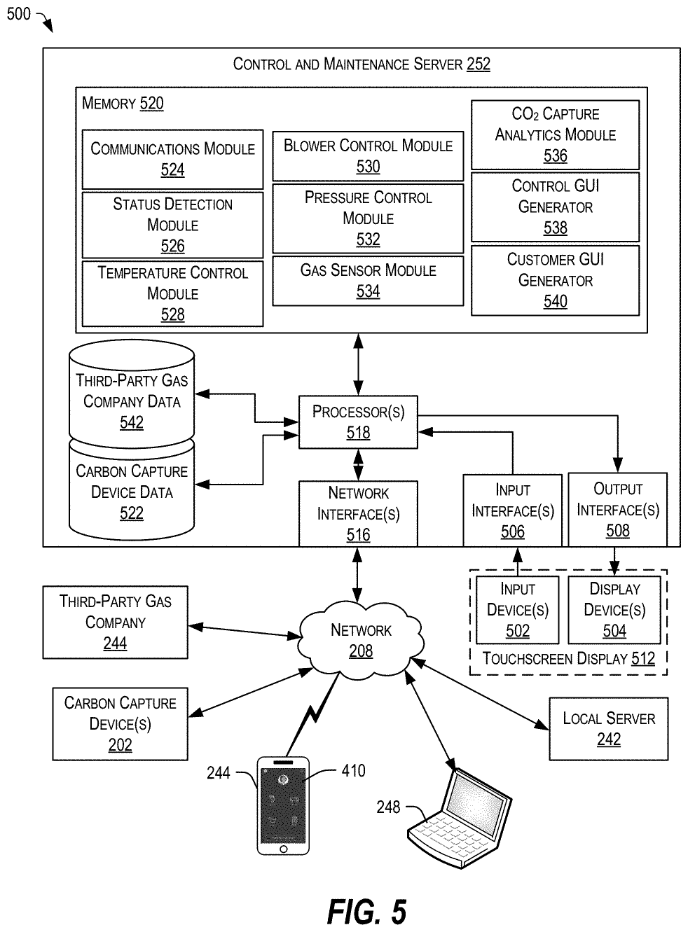

FIG. 5 depicts a block diagram 500 of the systems 100, 200, 300, and 400 of FIGS. 1-4 including a control and maintenance server 252 coupled to the device 202, in accordance with certain embodiments of the present disclosure. The control and maintenance server 252 may be configured to provide an interface to monitor and control a CO₂ capture device 202, in accordance with certain implementations of the present disclosure. The control and maintenance server 252 may be configured to communicate with one or more CO₂ capture devices 202, one or more computing devices 244 and 248, a local server 242, and one or more third-party gas companies 444.

The control and maintenance server 252 may be configured to interact with the local server 242 and optionally one or more of the CO₂ capture devices 202 to adjust one or more operating parameters, to report information, and so on. In some implementations, the control and maintenance server 252 may also be configured to provide information to computing devices of various individuals, including administrators and customers. The control and maintenance server 252 may include an input interface 506 coupled to an input device 502 and an output interface 508 coupled to a display device 504. In some implementations, the input device 502 and the display device 504 may be combined as a touchscreen display 512. The control and maintenance server 252 may include a processor 518 coupled to the input interface 506 and to the output interface 508. The control and maintenance server 252 may further include a network interface 516 coupled to the processor 518 and configured to couple to the network 208.

The control and maintenance server 252 may further include a memory 520 coupled to the processor 518, and may include databases including a third-party gas company database 542 and a carbon capture device database 522, which may be coupled to the processor 518. The third-party gas company database 542 may store data corresponding to companies that might be able to utilize and/or transport purified CO₂ gas generated and stored by the CO₂ capture device 202. The carbon capture device data 522 may be configured to store data associated with each of a plurality of CO₂ capture devices 202, including production information, data related to sensor measurements, parameter data, other data, or any combination thereof.

The memory 520 may include a communications module 524 that, when executed, may cause the processor 518 to communicate with the CO₂ capture devices 202 and optionally with a local server 242, and with other devices to receive information, to search for information, and so on. Such information may include quantities of excess CO₂ gas, location data indicating where the excess CO₂ gas is stored, contact information for an employee at the location, and so on. The communications module 524 may cause the processor 518 to communicate with each of a plurality of CO₂ capture devices 202 periodically, according to a pre-determined schedule, or continuously to retrieve the information. In some examples, the communications module 524 may be configured to passively receive the information. In some implementations, the communications module 524 may cause the processor 518 to receive data, such as sensor measurement data, purified CO₂ gas production data, parameter data, and other data from one or more CO₂ capture devices 202.

The memory 520 may also include a status detection module 526 that, when executed, may cause the processor 518 to determine a status of various components of at least one of the CO₂ capture devices 202 based on the received data. The status may include a state of a valve (open, closed, stuck, and so on), a state of the purified CO₂ storage device (such as the cryogenic storage 238), the state of various other components (such as scrubbers, blowers, compressors, sensor measurement data, and so on), or any combination thereof.

The memory 520 may include a temperature control module 528 that, when executed, may cause the processor 518 to determine a temperature of one or more components. Further, in response to determining the temperature, the temperature control module 528 may selectively determine one or more adjustments to parameters associated with components of the associated CO₂ capture device 202 that may be controlled to maintain the temperature within a pre-determined temperature range.

The memory 520 may also include a blower control module 530 that, when executed, may cause the processor 518 to determine information related to one or more blower components of the CO₂ capture device 202. Additionally, the blower control module 530 may cause the processor 518 to selectively determine one or more adjustments to parameters of the blower components of the associated CO₂ capture device 202 to adjust the output of the blowers.

The memory 520 may also include a pressure control module 532 that, when executed, may cause the processor 518 to determine information related to the fluid pressure at various points within the CO₂ capture process performed by the CO₂ capture device 202. In some implementations, the pressure control module 532 may be configured to cause the processor 518 to selectively determine one or more adjustments to parameters of one or more components the associated CO₂ capture device 202 to control the fluid pressure.

The memory 520 may also include a gas sensor module 534 that, when executed, may cause the processor 518 to extract the sensor measurement data from the data received from the CO₂ capture device 202. Further, the memory 520 may include a CO₂ capture analytics module 536 that, when executed, may cause the processor 518 to process the received data and the data determined by the status detection module 526, the temperature control module 528, the blower control module 530, the pressure control module 532, and the gas sensor module 534 to determine one or more adjustments associated with the CO₂ capture device 202. In some implementations, the CO₂ capture analytics module 536 may be configured to process data from each of a plurality of CO₂ capture devices 202, to determine parameters and settings that may enhance the CO₂ production for each CO₂ capture device 202 individually and optionally for establishing default settings that may provide an initial approximation for optimal production of purified CO₂ gas from the waste gas stream. In some implementations, the CO₂ capture analytics module 536 may provide recommended settings and suggested adjustments to an operator via a graphical interface.

The memory 520 may further include a control GUI generator 538 that, when executed, may cause the processor 518 to generate a graphical interface that may be provided to any of the computing devices (such as computing devices 244 and 248), to another device, or any combination thereof to facilitate control of the CO₂ capture device 202, remotely. The graphical interface may include data corresponding to parameters of a particular CO₂ capture device 202 and may include selectable options accessible by an operator to selectively adjust one or more of the parameters. Other implementations are also possible.

The memory 520 may also include a customer GUI generator 540 that, when executed, may cause the processor 518 to generate a graphical interface including data related to the operation of the CO₂ capture device 202 and to provide the graphical interface to a computing device, such as a smartphone, associated with a customer. The control and maintenance server 252 may determine proximity of the customer's computing device and may communicate the graphical interface to the computing device when the computing device is within a pre-determined range of a facility. Other implementations are also possible.

In some implementations, the system 100, 200, 300, 400, and 500 in FIGS. 1-5 may be implementations of the same system. In a particular example, the systems may provide a real-time network of hardware, software, and sensors configured to enable remote monitoring, analyzing, measuring, communicating, impacting, and controlling a CO₂ gas capture process. The systems may include a piece of field equipment (e.g., the CO₂ capture device 202) configured to CO₂ gas from a waste stream of mixed gas. The CO₂ capture device 202 may include sensors as described above with respect to FIGS. 1 and 2 to capture data corresponding to the CO₂ capture process. The data may include measurements corresponding to a plurality of chemical process input parameters (such as concentrations of compounds within the waste stream) and a set of chemical process output parameters. The circuit 214 of the CO₂ capture device 202 (or of the local server 242 or the control and maintenance serer 252) may be configured to determine a set of desired chemical process output parameters and may determine adjustments to one or more of the input and output process parameters to achieve the desired chemical process output parameters. Further, the CO₂ capture device 202 may be configured to communicate measurement data to one or more remote devices to enable remote monitoring and analysis of the CO₂ capture process. In some implementations, the application executing on the computing devices may include a version having an open Application Programming Interface (API) that allows customers to import data to a website and to process the data to track impact in real-time.

In some implementation, the system 100, 200, 300, 400, and 500 of FIGS. 1-5 may allow any piece of remote field equipment that performs complex chemical processing to be monitored, controlled, and operated remotely. Further, the control and maintenance server 242 or the local server 252 may be configured to allow an array of distributed field equipment (e.g., CO₂ capture devices) situated in different places (such as around the world) to be controlled primarily through a graphical interface provided to a computing device.

In an implementation, a system may include remotely monitoring, controlling, and analyzing a separation process of a waste gas stream that removes water, oxygen, and volatile organic compounds (VOCs) from the waste stream to produce a controlled product stream, such as purified CO₂. The system may include a plurality of field equipment for performing the separation process, each of which may be adapted to be responsive to electromagnetic signals resulting in control of a plurality of process parameters. The system may include a server including a hardware processor and a memory that may store data and processor-executable instructions. The system may further include a communications-link between the server and one or more pieces of field equipment.

In some implementations, the instructions stored in the memory, when executed, may cause the processor to establish a communications link between the field equipment and the server and to establish a client-server communications link between a user device and the server. Further, the instructions may cause the processor to provide a graphical interface to a display of a computing device through a network to present data related to a plurality of process parameters within the graphical interface on the display of the computing device. The instructions may also cause the processor to receive a set of separation process input parameters corresponding to parameters of an input stream of the CO₂ gas; receive a set of desired process output parameters corresponding to desired parameters of an output chemical stream comprising a CO₂ stream to control oxygen in the product streams; and selectively controlling a set of separation process control parameters to achieve the desired chemical process output parameters either automatically based on the input parameters and desired output parameters or in response to operator inputs.

In some implementations, the CO₂ capture device 202 may control the CO₂ capture process by monitoring oxygen within the waste stream to determine suitability to initiate (or continue) the CO₂ capture operation. In response to relatively high oxygen content, the CO₂ capture device 202 may determine and optionally control an inlet flow rate for the separation process, where the inlet flow rate may be controlled by an inlet control valve of the CO₂ capture device 202. Further, the CO₂ capture device 202 may be configured to determine a system operating pressure for the separation process, which system operating pressure may be controlled by a pressure control valve. Additionally, the CO₂ capture device 202 may be configured to determine a temperature set-point for the separation process, which temperature set-point may be controlled by a temperature controller. In some implementations, the CO₂ capture device 202 may adjust the inlet flow rate by the inlet control valve, the system operating pressure by the pressure control valve, and the temperature set-point by the temperature controller to maintain a desired temperature range and to provide a graphical interface (i.e., a human-machine interface (HMI)) adapted to allow supervisory intervention and specification of operating points to allow an operator to manually control the set of separation process control parameters.

In certain implementations, the separation process may include separating a raw CO₂ gas stream to improve purity by removing water, oxygen, and VOC products from the output product stream. In some implementations, the separation process may be configured to separate a raw fermentation gas to control CO₂ content into one CO₂ product stream, which may be in a liquid phase.

In some implementations, the communications link between the CO₂ capture device 202 and the local server 242 (or the control and maintenance server 252) may utilize a communication protocol selected from the group consisting of Modbus, CAN bus, TCP/IP, UDP, 3G, 4G, LTE, coaxial, IEEE 802.11a/b/g/n/x, IEEE 802.15.4, Bluetooth®, virtual private network (VPN), Internet Protocol security (IPsec), Internet Security Association and Key Management Protocol (ISAKMP), near-field communication, Fieldbus, 900 MHz radio, or any combination thereof. Additionally, in some implementations, the instructions may cause the processor to perform a process of controlling separation of a raw CO₂ gas stream by controlling one or more process parameters. The one or more process parameters may include an inlet flow rate of a raw natural gas stream, a system operating pressure, and a temperature set-point of a separation subsystem. The one or more process parameters may be controlled to maintain the desired CO₂ product temperature. In some implementations, the system operating pressure and the temperature set-point may be determined by one or more input parameters selected from the group including a desired oxygen content of the raw natural gas stream and a volume flow rate of the raw CO₂ gas stream. In some implementations, the CO₂ capture device 102 may control the inlet flow rate by controlling an inlet control valve or a compressor speed of one or more compressors.

In some implementations, the CO₂ capture device 202 may be configured to apply a timestamp to each measurement. In an example, the CO₂ volume measurements may be provided in various time measurements to allow customers (or customer devices) to analyze capture rates by time-interval, such as by minute, day, week, month, year, cumulative month-to-date, cumulative year-to-date, another time increment, or any combination thereof. Furthermore, this data may be spliced in various visual formats, including real-time data, monthly analysis, annual impact reports, other reports, or any combination thereof. In some implementations, the CO₂ volume data may be further calculated for impact and may be compared against CO₂ emissions reduction targets at organization, city, State, federal or international levels. The volume may be converted to compare environmental impacts (tree equivalents), economic savings, or another impact. In some implementations, the data may be presented within a graphical interface, which may be viewed on a mobile phone (such as a smartphone), a tablet computer, a laptop computer, video screen, a touchscreen, another electronic device, or any combination there. In some implementations, the data APIs may enable data sharing with multiple users, from system owners to consumers. Further, the data related to CO₂ emissions captured and avoided may be used to facilitate CO₂ emission reduction tax credits or rebates. Other implementations are also possible.

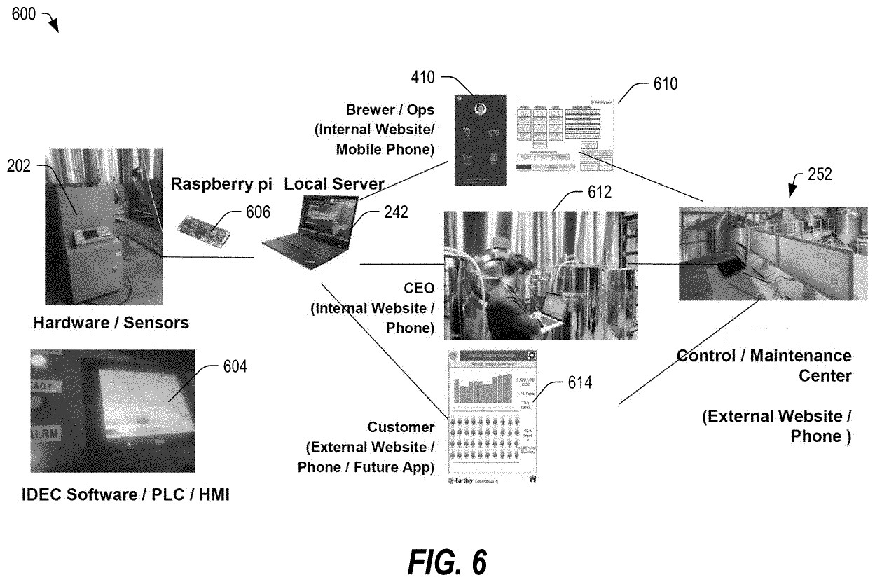

FIG. 6 depicts a diagram 600 of components of the system 100, 200, 300, 400, and 500 of FIGS. 1-5, in accordance with certain embodiments of the present disclosure. The CO₂ capture device 202 may include circuitry including a plurality of sensors and including a control circuit 606. In one implementation, the control circuit 606 may include a Raspberry PI®, which is a commercially available circuit product produced by the Raspberry Pi Foundation of the United Kingdom.

The CO₂ capture device 202 may include a display interface, such as a touchscreen display 604, which may be configured to display a graphical interface including data and selectable options accessible by an operator to selectively adjust one or more parameters. The CO₂ capture device 202 may communicate data, such as sensor data and other data corresponding to the production of purified CO₂ gas, to a local server 242.

In this example, the local server 242 may communicate a graphical interface 410 including data 610 and selectable options accessible by a brewer (or other operator) to review and optionally operation of the CO₂ capture device 202. The local server 242 may also communicate a graphical interface including data to employees of a company, such as a corporate officer, as shown at 612. The local server 242 may also provide data to a graphical interface of a customer device (e.g., a smartphone, another computing device, or any combination thereof) or to an external website.

The system 600 also includes a control and maintenance system 252, which may be configured to provide the data to the graphical interface 610, to the company employee at 612, or to the customer device 614. Other implementations are also possible.

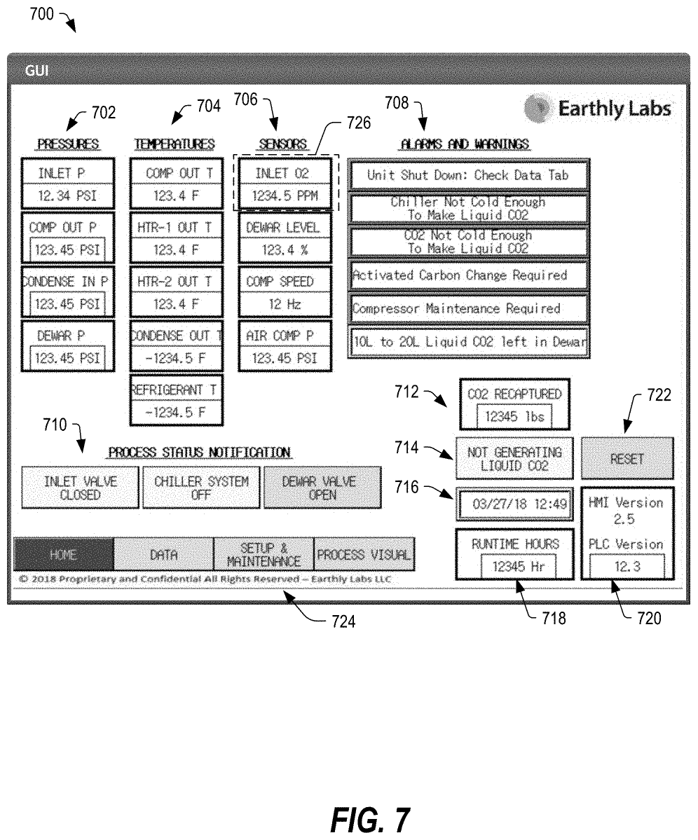

FIG. 7 depicts a diagram of a graphical interface 700 that may be presented on an interface of the device 102 of FIG. 1 or 202 of FIG. 2, in accordance with certain embodiments of the present disclosure. The graphical interface 700 may include collected data associated with a CO₂ capture device 202, in accordance with certain implementations of the present disclosure. The graphical interface 700 may include data corresponding to measurements by a plurality of pressure sensors, including a plurality of pressure measurements 702, including an inlet pressure, an outlet pressure, a condenser pressure, a Dewar pressure, other pressures, or any combination thereof. The graphical interface 700 may further include data corresponding to a plurality of temperature measurements 704, including a compressor outlet temperature, heater output temperatures, condenser output temperatures, refrigerant temperatures, other temperatures, or any combination thereof.

The graphical interface 700 may also include other sensor data corresponding to other sensors 706, such as an inlet gas content sensor, a Dewar level sensor, a compressor speed sensor, an air compressor pressure sensor, other sensors, or any combination thereof. Further, the graphical interface 700 may include data including a plurality of alarms and warnings, which may be generated automatically in response to comparing measurement data to one or more thresholds. The alarms and warnings may include a “Unit Shut Down: Check Data Tab” warning, a “Chiller Not Cold Enough to Make Liquid CO₂” warning, a “CO₂ Not Cold Enough” warning, an “Activated Carbon Change Required” warning indicating a change to the scrubber/filters is needed, a “Compressor Maintenance Required” warning, and a “10 L to 20 L Liquid CO₂ left in Dewar” warning.

The graphical interface 700 may also include a plurality of process status notifications 710, including an “Inlet Valve Closed” notification, a “Chiller System Off” notification, and a “Dewar Valve Open” notification. The graphical interface 700 may also include data including an indicator identifying an amount of CO₂ that has been recaptured, at 712. The graphical interface 700 may also include a “Not Generating Liquid CO₂” indicator 714, a date/time stamp 716, and an indicator 718 corresponding to a number of runtime hours of the CO₂ capture device 202. The graphical interface 700 may further include a “Reset” button 722 and version information 720 corresponding to the software executing on the circuitry of the CO₂ capture device 202.

The graphical interface 700 may also include a plurality of selectable options 724 accessible by the operator to access one or more screens of the graphical interface 700. The “Home” screen is displayed. Other selectable options 724 may include a “Data” option accessible by the operator to view measurement and production data and optionally to review the data in one or more selectable visualizations, including bar graphs, pie charts, line graphs, tables, other visualizations, or any combination thereof. The graphical interface 700 may include a “Setup and Maintenance” option accessible by an operator to adjust one or more settings, such as alerting thresholds and the like, and optionally to access options corresponding to maintenance operations. The graphical interface 700 may also include a “Process Visual” option accessible by an operator to view a visual representation of the components of the CO₂ capture device 202.

It should be appreciated that the graphical interface 700 represents one example of a graphical interface including data and selectable options. Other arrangements of the data and other selectable options are also possible.

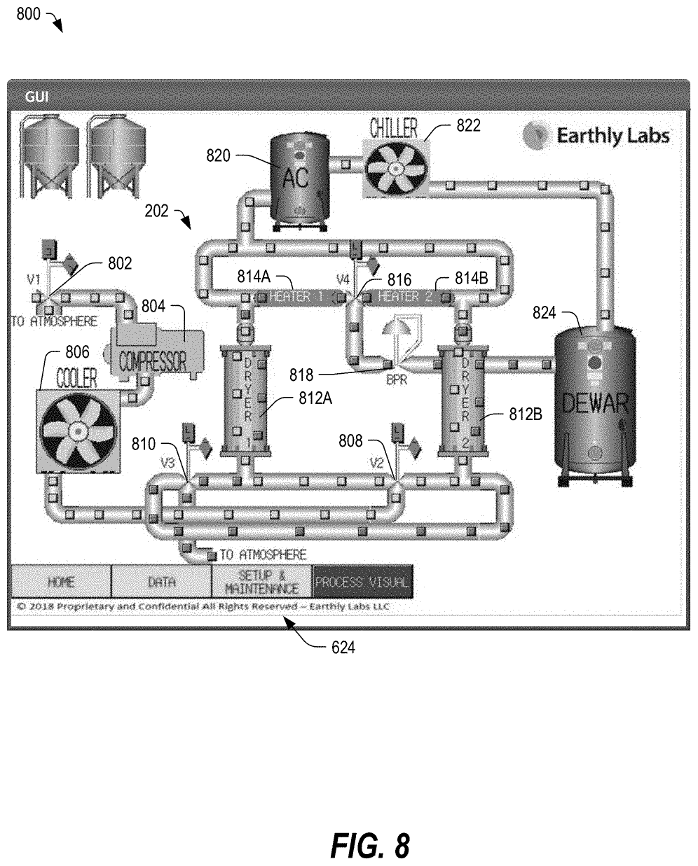

FIG. 8 depicts a diagram of a graphical interface 800 that may be presented on an interface of the device 102 or 202 of FIGS. 1 and 2, respectively, in accordance with certain embodiments of the present disclosure. The graphical interface 800 may include a graphical representation of the CO₂ capture device 202. The graphical interface 800 may include selectable options 624, and in this example the “Process Visual” option is selected, causing the graphical interface 800 to display a representation of components of the CO₂ capture device 202.

Within the graphical interface 800, the CO₂ capture device 202 may include an inlet valve 802 configured to couple a waste gas stream to an input port of a compressor 804, which may include an outlet port coupled to an input port of a cooler 806. The cooler 806 may include an output port coupled to dryers 812A and 812B through valves 808 and 810. The outputs of the dryers 812A and 812B may be coupled to an air conditioner 820 through a valve 816 and through heaters 814A and 814B. The CO₂ capture device 202 may further include a backflow valve 818. The air conditioner 820 may include an output coupled to an input of a chiller 822, which may chill the CO₂ gas into a liquid phase for storage within the Dewar 824.

The graphical interface 800 depicts a plurality of squares, each of which may represent a sensor configured to measure a parameter associated with the process. Such parameters may include a concentration of a compound within the stream, a temperature, a moisture level, another parameter, or any combination thereof. Each of the sensors may be coupled to a control circuit, which may control operation of the depicted components. Other implementations are also possible.

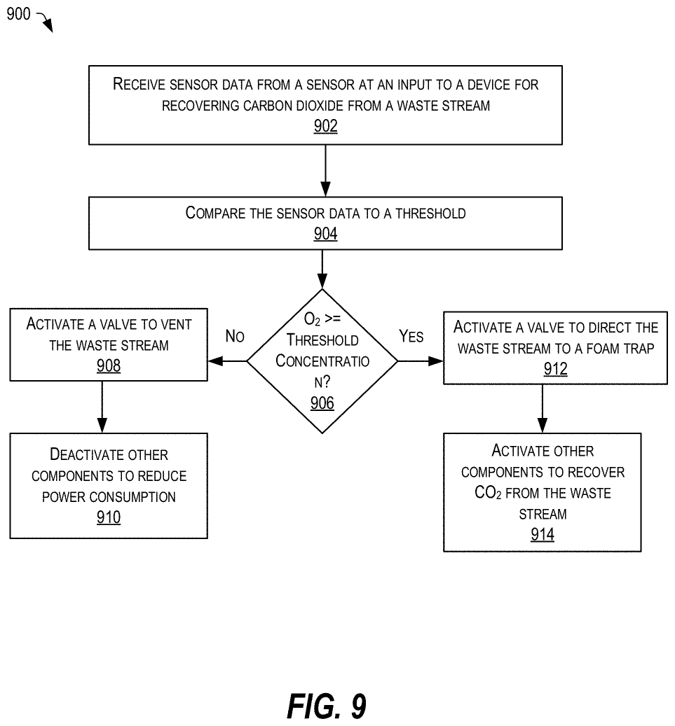

FIG. 9 depicts a flow diagram of a method 900 of selectively activating a device for recovering carbon dioxide, in accordance with certain implementations of the present disclosure. At 902, the method 900 may include receiving sensor data from a sensor at an input to a device for recovering CO₂ from a waste stream. The sensor data may include a signal proportional to a concentration of oxygen at the input.

At 904, the method 900 may include comparing the sensor data to a threshold. At 906, if the oxygen concentration is less than a threshold, the method 900 may include activating a valve to vent the waste stream, at 908. At 910, the method 900 may include deactivating other components to reduce power consumption.

Returning to 906, if the oxygen concentration is greater than or equal to a threshold, the method 900 may include activating the valve to direct the waste stream to a foam trap, at 912. The foam trap may remove foam and liquid from the waste stream. At 914, the method 900 may further include activating other components to recover CO₂ from the waste stream.

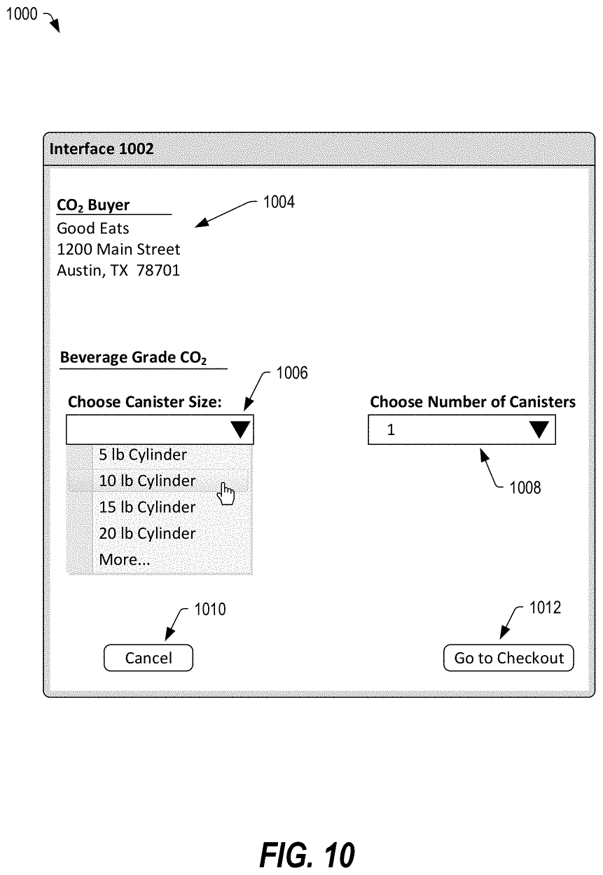

FIG. 10 depicts a diagram 1000 of an interface 1002 with which a consumer may interact to purchase a quantity of captured CO₂, in accordance with certain embodiments of the present disclosure. The interface 1002 may include data 1004 indicative of a CO₂ buyer. The interface 1002 may further include a selectable control 1006, such as a pull-down menu, text, field, checkbox, or other control that can be accessed by a user to specify a canister size. The interface 1002 may include a selectable control 1008 to specify a quantity of canisters. The interface 1002 may further include a “Cancel” button 1010 and a “Go to Checkout” button 1012. Other implementations are also possible.

In this example, a user may access the interface 1002 to select canister sizes and a quantity of canisters and then to proceed to checkout to complete a purchase transaction. It should be appreciated that this is one of many possible examples of a purchase interface through which a user may order or purchase a quantity of captured CO₂ gas. Additionally, in some implementations, during the checkout process, the system may provide one or more controls to enable the user to select delivery or pickup options. In response to selection of a delivery option, the system may add additional charges for shipping and handling and may automatically schedule pickup and delivery of the selected one or more CO₂ canisters.

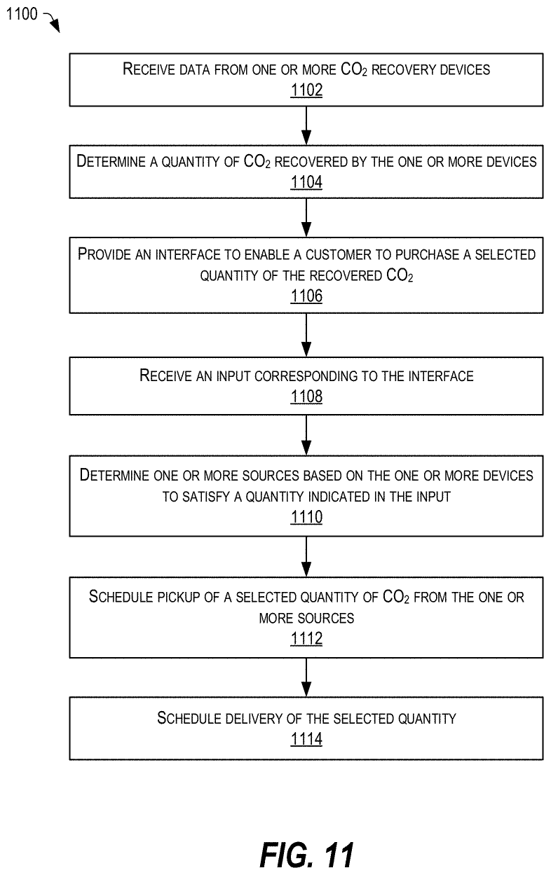

FIG. 11 depicts a flow diagram of a method 1100 of providing captured CO₂, in accordance with certain embodiments of the present disclosure. At 1102, the method 1100 may include receiving data from one or more CO₂ recovery devices. The data may include information indicative of a quantity of excess CO₂, location data indicating a current location of the CO₂, employee contact information associated with the location, other data, or any combination thereof.

At 1104, the method 1100 may include determining a quantity of CO₂ recovered by the one or more devices. The quantity may be determined from the data. In some implementations, the quantity may be determined by polling one or more of the CO₂ recovery devices, for example, in response to receiving the data.

At 1106, the method 1100 may include providing an interface to enable a customer to purchase a selected quantity of the recovered CO₂. The interface may be rendered within an Internet browser application. In some implementations, a server may provide the interface including one or more control options accessible by the user to select the size and quantity of one or more CO₂ canisters.

At 1108, the method 1100 may include receiving an input corresponding to the interface. The input may correspond to one or more control options provided within the interface. In some implementations, the input may include the canister size, the quantity, delivery information, and so on.

At 1110, the method 1100 may include determining one or more sources based on the one or more devices to satisfy a quantity indicated in the input. For example, the system may include data from multiple CO₂ capture devices 102. The system may determine one or more locations to satisfy the requested quantity.

At 1112, the method 1100 may include scheduling pickup of a selected quantity of CO₂ from the one or more sources. For example, the system may communicate with one or more carriers and with one or more employees at the location to schedule pickup of the quantity of CO₂. In an implementation, the system may send an electronic message to the employee to request a pickup time range and may coordinate with one or more carriers to pickup the quantity of CO₂ within the specified time range. Other implementations are also possible.

At 1114, the method 1100 may include scheduling delivery of the selected quantity. For example, the system may coordinate with one or more employees associated with the purchaser to arrange delivery of the product. In an example, the system may send an email or other electronic message to one or more employees indicating a time range within which the quantity may be delivered. Other implementations are also possible.

In conjunction with the systems, devices, and methods described above with respect to FIGS. 1-11, a device may include an input to receive a waste stream, a plurality of sensors, and a control circuit coupled to the plurality of sensors. The control circuit may be configured to determine a concentration of oxygen within the waste stream and to selectively activate the carbon dioxide capture process when the oxygen content is equal to or exceeds a pre-determined threshold. When the oxygen concentration is less than the threshold, the control circuit may deactivate the CO₂ processing components and optionally vent the waste stream to atmosphere or back to the source of the waste stream.

Although the present invention has been described with reference to preferred embodiments, workers skilled in the art will recognize that changes may be made in form and detail without departing from the scope of the invention.

What is claimed is:

1. A device comprising:
a plurality of controllable components;
an input to receive a waste stream including carbon dioxide (CO₂) and volatile organic compounds;
a foam trap coupled to the input;
one or more sensors coupled to the input, the one or more sensors including a first sensor to generate an electrical signal proportional to a concentration of at least one compound within the waste stream; and
a control circuit coupled to the one or more sensors, the control circuit to selectively activate one or more of the plurality of controllable components in response to the electrical signal to recover the CO₂ from the waste stream.

2. The device of claim 1, wherein the control circuit includes a communication interface to send data to and receive data from a computing device through a communications link, the data indicative of a volume of the CO₂ recovered from the waste stream.

3. The device of claim 1, wherein the plurality of controllable components comprises one or more of:
a compressor;
a dehydrator;
a scrubber;
a chiller system; or
a plurality of valves.

4. The device of claim 1, further comprising a valve including:
a valve input coupled to the input;
a control input coupled to the control circuit;
a first valve output configured to expel the waste stream; and
a second valve output coupled to the foam trap; and
wherein the control circuit selectively activates the valve via the control input.

5. The device of claim 4, wherein:
the concentration of the at least one compound is greater than a threshold value; and
the control circuit controls the valve to:
direct the waste stream through the second valve output when the oxygen concentration within the waste stream is equal to or exceeds a threshold; and
direct the waste stream through the first valve output when the oxygen concentration is below the threshold.

6. A system comprising:
a communication interface to couple to a network to send and receive data; and
a processor coupled to the interface, the processor to:
receive first data corresponding to an available quantity of carbon dioxide (CO₂) from one or more CO₂ capture devices;
provide an interface to one or more computing devices through the network, the interface including CO₂ data related to the available quantity of CO₂ and including one or more control options accessible by a user to purchase a selected portion of the available quantity; and
receive second data corresponding to selections from the interface from a purchaser, the selections including a selected quantity from the available quantity of CO₂; and
automatically coordinate one or more of pickup or delivery of the selected quantity.

7. The system of claim 6, wherein the processor automatically coordinates the pickup of the selected quantity by sending an electronic message to an employee at a location associated with the selected quantity.

8. The system of claim 6, wherein the processor automatically coordinates the delivery of the selected quantity by sending an electronic message to the purchaser.
